(19) United States
(12) Patent Application Publication
(10) Pub. No.: US 2021/0281787 A1
(43) Pub. Date: Sep. 9, 2021

(54) READOUT CIRCUITRY IN IMAGE SENSORS

(71) Applicant: SEMICONDUCTOR COMPONENTS INDUSTRIES, LLC, Phoenix, AZ (US)

(72) Inventors: Nicholas Paul COWLEY, Wroughton (GB); Richard James GOLDMAN, Cirencester (GB); Tomas GEURTS, Haasrode (BE)

(73) Assignee: SEMICONDUCTOR COMPONENTS INDUSTRIES, LLC, Phoenix, AZ (US)

(21) Appl. No.: 16/808,737

(22) Filed: Mar. 4, 2020

(51) Int. Cl. H04N 5/378; H04N 5/3745

(52) U.S. Cl. CPC H04N 5/378; H04N 5/37452

(57) ABSTRACT

An image sensor may include a pixel array coupled to column readout circuitry. The pixel array may be split into multiple sub-arrays. Readout circuitry may be shared between multiple columns in each sub-array or in the pixel array. The readout circuitry may be coupled to at least first and second pixels in first and second different columns. The readout circuitry may include amplifier circuitry that receives signals from both the first and second pixels. Two input capacitors for the amplifier circuitry may form two corresponding memory circuits, for the first and second columns, respectively. Two feedback capacitors for the amplifier circuitry may form two corresponding memory circuits, for the first and second columns, respectively. The readout circuitry may be configured to perform a shared reset level readout operation for the first and second pixels and to perform separate correlated double sampling readout operations for the first and second pixels.

### BACKGROUND

This relates generally to imaging devices and systems, and more particularly, to image sensors that include shared readout circuitry (e.g., shared amplifier circuitry).

Image sensors are commonly used in electronic devices such as cellular telephones, cameras, and computers to capture images. In a typical arrangement, an image sensor includes an array of image pixels arranged in pixel rows and pixel columns. Column readout circuits are each typically coupled to a corresponding pixel column for reading out image signals from each of the image pixels in that corresponding pixel column.

However, in large image pixel arrays such as stitched pixel arrays, issues can arise when trying to perform readout operations using this per-column readout circuit configuration. In particular, column line (or path) settling is one of the dominant factors in determining the efficiency of the readout operations (e.g., the frame rate of the image sensor). With a dramatic increase in the number of pixel rows in these large image pixel arrays, column line settling time will also dramatically increase (e.g., a doubling of pixel rows may lead to a quadratic increase of the settling time). This will undesirably reduce the frame rate of the image sensor. Additionally, given the length of the column lines, each of which spans the large number of pixel rows, the resistive drops across the column lines spanning the array can further contribute to gradient-like image artifacts.

In some instances, additional power can be supplied to the column lines to improve settling time. However, this undesirably increases power consumption, and in some cases, require different power supply implementations. Increased current can also increase adversely impact the dynamic range of signals received at the column amplifier. In other instances, the large arrays can be split into smaller subarrays, which have separate readout paths (e.g., a single column of the large array can have two sets of readout circuits, each associated with a portion of a corresponding smaller subarray). However, this increases the number of readout circuits and the amount of digital processing required for processing the signals from each of the readout circuits.

It would therefore be desirable to provide imaging devices and systems with improved image sensors that take into account the above issues.

### BRIEF DESCRIPTION OF THE DRAWINGS

FIG. 1 is a block diagram of an illustrative imaging system having processing circuitry and an image sensor for capturing images in accordance with some embodiments.

FIG. 2 is a block diagram of an illustrative image sensor that includes an image pixel array and readout circuitry and that may be implemented in an imaging system such as the imaging system shown in FIG. 1 in accordance with some embodiments.

FIG. 3 is a block diagram of an illustrative split image sensor pixel array coupled to shared column readout circuitry in accordance with some embodiments.

FIG. 4 is a circuit diagram of an illustrative image sensor pixel in accordance with some embodiments.

FIG. 5 is a circuit diagram of illustrative shared readout circuitry such as illustrative shared amplifier circuitry in the shared readout circuitry in accordance with some embodiments.

FIG. 6 is a flowchart of illustrative steps for operating shared readout circuitry such as the shared readout circuitry shown in FIG. 5 in accordance with some embodiments.

### DETAILED DESCRIPTION

Embodiments of the present invention relate to image sensors, and more particularly, to image sensors that include shared readout circuitry (e.g., shared amplifier circuitry) and to the operations of the image sensors including the shared readout circuitry. It will be recognized by one skilled in the art that the present exemplary embodiments may be practiced without some or all of these specific details. In other instances, well known operations have not been described in detail in order to not unnecessarily obscure the present embodiments.

Imaging systems having camera modules are widely used in electronic devices such as digital cameras, computers, cellular telephones, and other electronic devices and systems. A camera module may include one or more image sensors that gather incoming light to capture images. Image sensors may include arrays of image pixels (i.e., image pixel arrays). The pixels in the image sensors may include photosensitive elements such as photodiodes that each convert the incoming light into electric charge. Image sensors may have any number of pixels (e.g., hundreds or thousands, or more). A typical image sensor may, for example, have hundreds, thousands, or millions of pixels (e.g., megapixels). Image sensors may include control circuitry such as circuitry for operating the image pixels and readout circuitry for reading out image signals corresponding to the respective electric charges generated by the photosensitive elements.

The image sensor pixels in different columns of the image pixel array may be coupled to shared readout circuitry (e.g., shared amplifier circuitry or shared column amplifier circuitry) to enable improved readout efficiency, especially for large image sensor arrays. In particular, by sharing the readout circuitry between different columns of the image sensor array, some readout circuitry (on a per-column basis) may be omitted while still achieving a satisfactory frame rate for the image sensor. Additionally, by sharing the readout circuitry between the different columns of the array, the number of reset level voltage readout operations for corresponding pixels sharing the readout circuitry may be reduced.

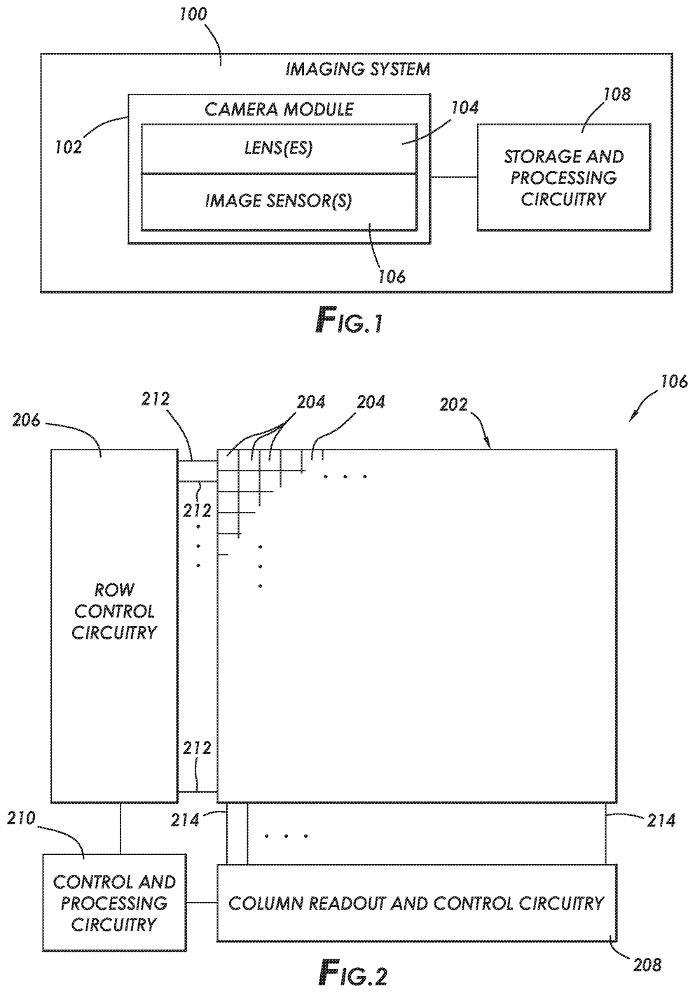

FIG. 1 is a diagram of an illustrative imaging system (e.g., imaging system 110) such as an electronic device that uses an image sensor to capture images. As examples, electronic device 100 of FIG. 1 may be a portable electronic device such as a camera, a cellular telephone, a tablet computer, a webcam, a video camera, or any other desired imaging system or device that captures digital image data such as a video surveillance system, an automotive imaging system, a video gaming system with imaging capabilities, etc. Camera module 102 may be used to convert incoming light into digital image data. Camera module 102 may include one or more lenses 104 and one or more corresponding image sensors 106. Lenses 104 may include fixed and/or adjustable lenses, and may include microlenses formed on an imaging surface of an image sensor 106. During image capture operations, light from a scene may be focused onto an image sensor 106 by lenses 104. Image sensor(s) 106 may include circuitry for converting analog pixel signals into corresponding digital image data to be provided to storage and processing circuitry 108. If desired, camera module 102 may be provided with an array of lenses 104 and an array of corresponding image sensors 106.

Storage and processing circuitry 108 may include one or more integrated circuits (e.g., image processing circuits, microprocessors, storage devices such as random-access memory and non-volatile memory, etc.) and may be implemented using components that are separate from camera module 102 and/or that form part of camera module 102 (e.g., circuits that form part of an integrated circuit that includes one or more image sensors 106 or an integrated circuit within module 102 that is associated with one or more image sensors 106). Image data that has been captured by camera module 102 may be processed and stored using storage and processing circuitry 108 (e.g., using an image processing engine on processing circuitry 108, using an imaging mode selection engine on processing circuitry 108, etc.). Processed image data may, if desired, be provided to external equipment (e.g., a computer, external display, or other devices) using wired and/or wireless communications paths coupled to processing circuitry 108.

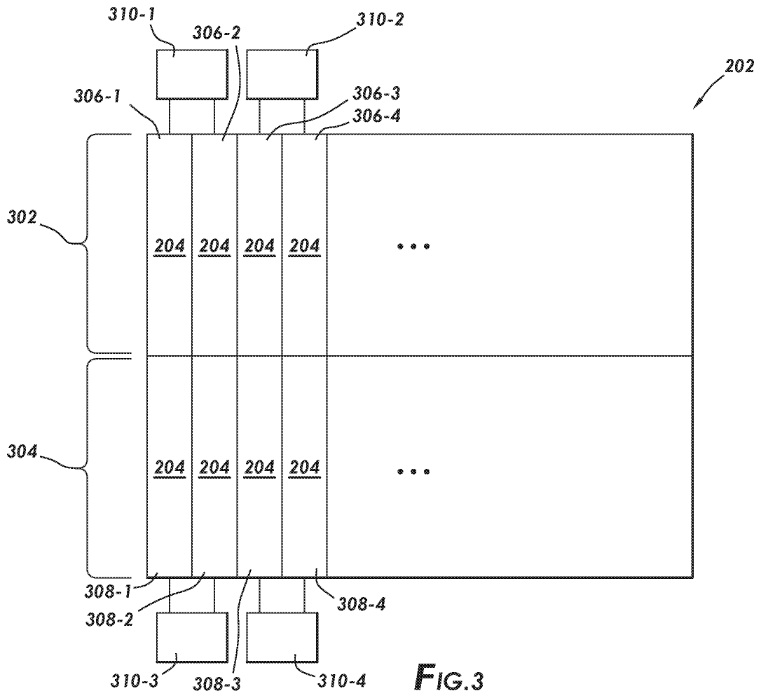

As shown in FIG. 2, an image sensor such as image sensor 106 may include a pixel array 202 containing image sensor pixels 204 (sometimes referred to herein as image pixels or pixels) arranged in (pixel) rows and (pixel) columns, and may include control and processing circuitry 210. Array 202 may contain, for example, hundreds or thousands of rows and columns of image sensor pixels 204. Control circuitry 210 may be coupled to row control circuitry 206 and image readout circuitry 208 (sometimes referred to as column control circuitry, column readout circuitry, readout circuitry, or column decoder circuitry). Row control circuitry 206 may receive row addresses from control circuitry 210 and supply corresponding row control signals such as reset, row-select, charge transfer, dual conversion gain, and readout control signals, or other control signals to pixels 204 over conductive paths such as row control paths 212. One or more conductive paths or lines such as column lines 214 may be coupled to each column of pixels 204 in array 202. Column lines 214 may be used for reading out image signals from pixels 204 and for supplying bias signals (e.g., bias currents or bias voltages) to pixels 204. If desired, during pixel readout operations, a pixel row in array 202 may be selected using row control circuitry 206, and image signals generated by image pixels 204 in that pixel row may be read out along column lines 214.

Readout circuitry 208 may receive image signals (e.g., analog image signals generated by pixels 204) and other pixel signals (e.g., reset level signals, reference level signals, etc.) over column lines 214. Readout circuitry 208 may include sample-and-hold circuitry for sampling and temporarily storing image signals read out from array 202, amplifier circuitry (sometimes referred to herein as column amplifier circuitry), analog-to-digital converter (ADC) circuitry, bias circuitry, column memory circuitry (e.g., a line buffer), latch circuitry for selectively enabling or disabling one or more portions of readout circuitry 208, or other circuitry that is coupled to one or more columns of pixel array 202 for operating pixels 204 and/or for reading out image signals from pixels 204. Sample-and-hold circuitry in readout circuitry 208 may be used to read out charge generated by image pixels 204 and a reset level voltage for performing correlated double sampling operations. ADC circuitry in readout circuitry 208 may convert analog image signals received from array 202 into corresponding digital pixel data (sometimes referred to herein as digital image data or simply image data). Readout circuitry 208 may supply digital pixel data to control and processing circuitry 210 and/or storage and processing circuitry 108 (FIG. 1) for pixels in one or more pixel columns.

If desired, image pixels 204 may include one or more photosensitive regions for generating charge in response to image light (sometimes referred to herein as incident or incoming light). Photosensitive regions within image pixels 204 may be arranged in rows and columns on array 202. Pixel array 202 may be provided with a color filter array having multiple color filter elements, thereby allowing a single image sensor to sample light of different colors. As an example, image sensor pixels such as image pixels 204 in array 202 may be provided with a color filter array, which allows a single image sensor to sample red, green, and blue (RGB) light using corresponding red, green, and blue image sensor pixels (e.g., corresponding image pixels, over which red, green, and blue filter elements are formed) arranged in a Bayer mosaic pattern. The Bayer mosaic pattern consists of a repeating unit cell of two-by-two image pixels, with two green image pixels diagonally opposite one another and adjacent to a red image pixel diagonally opposite to a blue image pixel. In another suitable example, the green pixels in a Bayer mosaic pattern may be replaced by broadband image pixels having broadband color filter elements (e.g., clear color filter elements, yellow color filter elements, etc.) formed over the corresponding image pixels. These examples are merely illustrative and, in general, color filter elements of any desired color or filter elements for one or more wavelengths, and in any desired pattern may be formed over any desired number of image pixels 204.

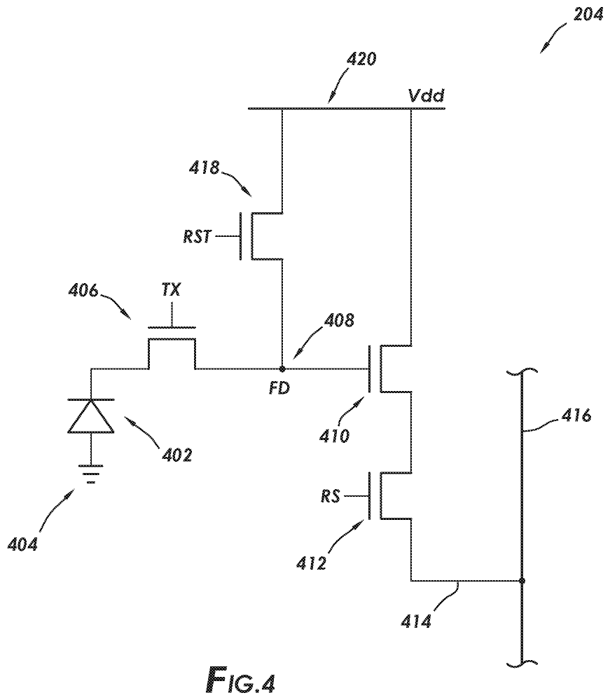

In some applications (e.g., applications utilizing image sensors with large image pixel arrays), it may be desirable to split a pixel array such as pixel array 202 into multiple sections for operational efficiency (e.g., for readout efficiency). FIG. 3 is a diagram of an illustrative configuration for pixel array 202 that include multiple sections or portions (e.g., portion 302 and 304). These portions may be referred to herein as pixel sub-arrays (i.e., sub-array 302 and sub-array 304) or rows of pixels 302 and rows of pixels 304.

In the example of FIG. 3, array 202 may be split vertically (e.g., along a horizontal line), thereby defining a top portion 302 and a bottom portion 304. Top portion 302 may include columns 306 of pixels 204, and similarly, bottom portion 304 may include columns 308 of pixels 204. Because array 202 in FIG. 3 is split vertically (e.g., column wise) into two sub-arrays, columns 306 in portion 302 and corresponding columns 308 in portion 304 may form a complete column in array 202. This configuration of array 202 in FIG. 3 is merely illustrative. If desired, array 202 may not be split into different sub-arrays (e.g., as in the configuration shown in FIG. 2), or may be split into three different sub-arrays, may be split into four sub-arrays, may be split into five or more sub-arrays, etc. If desired, array 202 may be split into two or more sub-arrays in any suitable manner.

While, in the example of FIG. 3, portions 302 and 304 are adjacent to one another, this is merely illustrative. If desired, portions 302 and 304 may be separated by pixels (e.g., one or more rows of pixels), may be separated by isolation structures, may be part of completely different arrays, or may be disposed in any other suitable configuration relative to each other.

By separating array 202 in FIG. 3 into separate portions, each portion may include its own dedicated circuitry. As an example, top portion 302 may be coupled to readout circuitry separate from the readout circuitry coupled to bottom portion 304. In such a manner, pixel signals from pixels 204 in top portion 302 may be read out through corresponding upward-extending column readout lines or paths separately from column readout lines or paths for pixels 204 in bottom portion 304. Similarly, pixel signals from pixels 204 in bottom portion 304 may be read out through corresponding downward-extending column readout lines or paths.

In other words, pixels 204 in a single column in array 202 (include a column portion 306 and a column portion 308) may be read out either upward or downward (in the orientation of FIG. 3) to different corresponding readout circuitry. In this configuration, column (readout) lines may not span the entire column length of array 202. In particular, a first (upper) column line may span the column length of portion 302 in array 202, and a second (lower) column line may span the column length of portion 304 in array 202 (e.g., the first column line may be coupled to an upper set of pixels 204, the second column line may be coupled to a lower set of pixels 204, the upper and lower sets of pixels 204 being in the same column of array 202).

Because separate readout circuitries are provided for different portions of pixels along the same column, and the length of corresponding column lines in the upper and lower portions are shortened (relative to an unsplit array 202 as shown in FIG. 2), readout efficiency for array 202 may be improved (e.g., the frame rate of the image sensor 106 including split array 202 may be improved). However, this comes at the cost of additional readout circuitry for each (upper or lower) column portion of different portions of array 202, and additional processing circuitry for processing the signals read out from each of the additional readout circuitry (e.g., additional circuitry to increase processing bandwidth).

To mitigate these issues, two or more upper or lower column portions of array 202 (e.g., two or more columns of each of portions 302 and 304) may share readout circuitry. As shown in FIG. 3, a first (upper) column 306-1 of pixels 204 in sub-array 302 may be coupled to readout circuitry 310-1, and a second (upper) column 306-2 of pixels 204 in sub-array 302 may be coupled to the same readout circuitry 310-1. Similarly, third and fourth (upper) columns 306-3 and 306-4 of pixels 204 may be coupled to same readout circuitry 310-2. This bi-column pattern of shared readout circuitry may be used for all columns of sub-array 302. In other words, pixels 204 in every two columns of sub-array 302 may be coupled to corresponding shared readout circuitry.

Likewise for sub-array 304, pixels 204 in every two columns of sub-array 304 may be coupled to shared readout circuitry. In particular, as shown in FIG. 3, first and second (lower) columns 308-1 and 308-2 of pixels 204 may be coupled to same readout circuitry 310-3. Also, third and fourth (lower) columns 308-3 and 308-4 of pixels 204 may be coupled to same readout circuitry 310-4.

The exemplary configuration in FIG. 3 showing shared readout circuitry 310 for every two columns of sub-arrays 302 or 304 is merely illustrative. If desired, readout circuitry may be shared between more than two columns of pixels 204 in sub-arrays 302 or 304, or between any other suitable pixels in array 202. As an example, columns 308-1 and 308-3 (non-adjacent columns) in portion 304 may be coupled a shared readout circuitry 310, and columns 308-2 and 308-4 in portion 304 may be coupled to another shared readout circuitry 310. In this manner, green pixels or other pixels of the same color may be read out to shared readout circuitry 310 if desired. This configuration for sharing readout circuitry 310 may similarly be applied to non-adjacent columns in portion 302 (as another example).

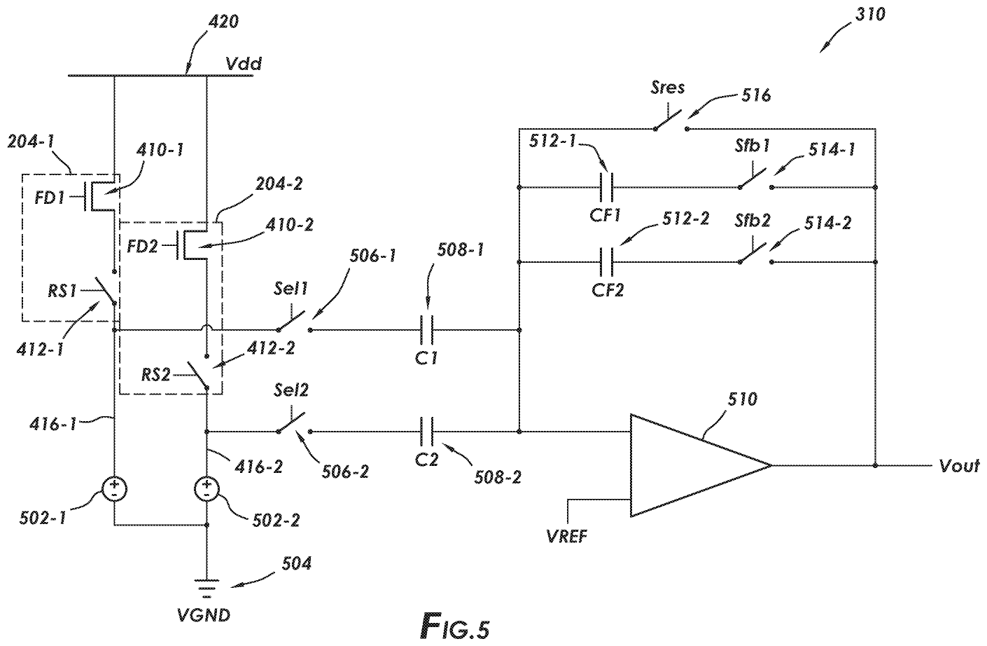

FIG. 4 is a diagram of an illustrative pixel that may be implemented as one or more pixels 204 in FIGS. 2 and/or 3. In particular, as shown in FIG. 4, pixel 204 may include a photosensitive element such as photosensitive element 402 (e.g., photodiode 402). Photosensitive element 402 may have two terminals, a first terminal coupled to a reference voltage terminal (e.g., a ground voltage terminal 404) and a second terminal coupled to a transfer transistor (e.g., transistor 406). During image acquisition operations, photosensitive element 402 may convert incoming light (photons) into electrical charge (e.g., may generate electrical charge based on or in response to incoming light). Transistor 406 may be controlled by control signal TX to selectively transfer the generated charge to a floating diffusion region (FD) such as floating diffusion region 408 for readout operations. Floating diffusion region 408 may exhibit a capacitance for temporarily storing the transferred charge. The transferred charge may be conveyed onto a column line (e.g., column lines 416) as an image signal (sometimes referred to herein as an image level signal) during a readout operation.

In particular, floating diffusion region 408 may be coupled to a gate terminal of source follower transistor 410. Source follower transistor 410 may include a first source-drain terminal (i.e., one of a source terminal or a drain terminal) coupled to supply voltage terminal 420 (e.g., supplying voltage Vdd) and a second source-drain terminal (the other one of the source terminal or the drain terminal) coupled to pixel output path 414. Row select transistor 412 may be interposed between source follower transistor 410 and pixel output path 414. During readout operations, row select transistor 412 may be activated (e.g., turned on) by asserting control signal RS. Pixel output path 414 may be coupled to column line 416 shared by a column of pixels or shared by a column portion of pixels (e.g., a column of pixels in portion 302 or portion 304 in the split array configuration in FIG. 3).

Pixel 204 may also include reset transistor 418 coupled between supply voltage terminal 420 and floating diffusion region 408. Reset transistor 418 may be activated by asserting control signal RST. Activating transistor 418 may reset floating diffusion region 408 to a reset level voltage (e.g., voltage at supply voltage terminal 420 such as voltage Vdd). This may occur before transistor 406 transfers the charge generated by photodiode 402 to floating diffusion region 408, and may reset any noise and/or previously stored signals on floating diffusion region 408. The reset level voltage may also be conveyed onto column line 416 via transistor 410 and 412 during a readout operation as a reset level signal. By reading out (e.g., sampling) the reset level signal before reading out (e.g., sampling) the image level signal, the corresponding readout circuitry coupled to pixel 204 may perform a correlated double sampling (CDS) readout operation of the image level signal based on the reset level signal. If desired, transistor 418 may be used (in combination with transistor 406) to reset photosensitive element 402.

The configuration of pixel 204 in FIG. 4 is merely illustrative. If desired, pixel 204 may include additional charge storage structures (e.g., a low-gain capacitor coupled to floating diffusion region 408 via a dual conversion gain transistor, one or more storage diodes or gates between photodiode 402 and floating diffusion region 408, etc.). If desired, pixels 204 may include additional transistors (e.g., an anti-blooming transistor coupled to photosensitive element 402, transistors along parallel paths coupling photosensitive elements 402 to floating diffusion region 408, etc.). If desired, pixels 204 may include any other suitable structures. Additional details regarding the configuration of pixel 204 are omitted herein in order to not unnecessarily obscure the embodiments of the present invention.

In order to provide image sensor 106 (e.g., in FIGS. 1 and 2 or an image sensor that includes different sub-arrays described in connection with FIG. 3) with shared readout circuitry compatible with connecting to and reading out from pixels 204 in different columns, the shared readout circuitry may include analog memory circuits.

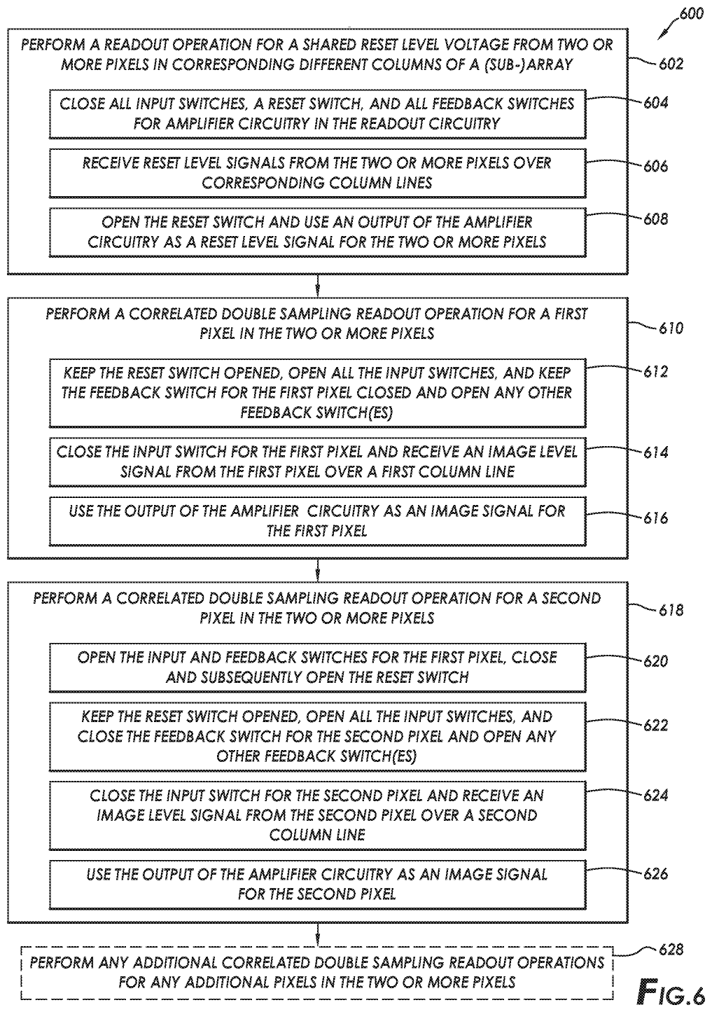

FIG. 5 is a diagram of illustrative readout circuitry (e.g., readout circuitry 310) that includes analog memory circuits and that includes connections to pixels 204 in different columns (e.g., pixel 204-1 in a first column and pixel 204-2 in a second column). Other pixels in the first and second different columns are not shown in FIG. 5 in order to not unnecessarily obscure the present embodiments.

In particular, readout circuitry 310 in FIG. 5 may be implemented in each of shared readout circuitries 310-1, 310-2, 310-3, and 310-4 in FIG. 3 and/or may be implemented in column readout and control circuitry 208 in FIG. 2 with shared readout circuitry in a bi-column configuration similar to the configuration described in connection with FIG. 3. As an example, pixels 204-1 and 204-2 may be a first pixel in column 306-1 in sub-array 302 in FIG. 3 and a second pixel in column 306-2 in sub-array 302, respectively. As another example, pixels 204-1 and 204-2 may be a first pixel in column 308-1 in sub-array 304 in FIG. 3 and a second pixel in column 308-2 in sub-array 304, respectively. As yet another example, pixels 204-1 and 204-2 may be a first pixel in a first column in (unsplit) array 202 in FIG. 2 and a second pixel in a second column in (unsplit) array 202 in FIG. 2, respectively. These examples are merely illustrative. If desired, pixels 204-1 and 204-2 may be implemented as any suitable pixels in one or more sub-arrays or arrays (e.g., any suitable pixel column having these two pixels may be coupled to shared readout circuitry 310).

As shown in FIG. 5, readout circuitry 310 may be coupled to pixels 204-1 and 204-2 via respective column lines 416-1 and 416-2. In particular, pixel 204-1 may include source follower transistor 410-1 and row select switch 412-1 (e.g., implemented as a row select transistor in FIG. 4) that couple other components of pixel 204-1 (e.g., a photosensitive region, a floating diffusion region, etc., as shown in FIG. 4) to column line 416-1. A voltage source such as voltage source 502-1 (or a current source) may provide a bias voltage (or current) on column line 416-1 for reading out signals from pixel 204-1 and other pixels (in the same column or column portion) coupled to column line 416-1.

Similarly, pixel 204-2 may include source follower transistor 410-2 and row select switch 412-2 (e.g., implemented as a row select transistor in FIG. 4) that couple other components of pixel 204-2 (e.g., a photosensitive region, a floating diffusion region, etc., as shown in FIG. 4) to column line 416-2. A voltage source such voltage source 502-2 (or a current source) may provide a bias voltage (or current) on column line 416-2 for reading out signals from pixel 204-2 and other pixels (in the same column or column portion) coupled to column line 416-2.

As shown in FIG. 5, readout circuitry 310 may include amplifier circuitry 510 (e.g., an operational amplifier). Amplifier circuitry may have first and second input terminals. The first input terminal may be coupled to a voltage source supplying reference voltage VREF. The second input terminal may be coupled to column lines 416-1 and 416-2 via corresponding input capacitors 508-1 and 508-2 along separate paths.

As shown in FIG. 5, pixel 204-1 may be coupled to the second input terminal of amplifier circuitry 510 via switch 506-1 and capacitor 508-1, which are connected in series. Pixel 204-2 may be coupled to the same second input terminal of amplifier circuitry 510 via switch 506-2 and capacitor 508-2, which are connected in series. By providing a switch (e.g., switch 506) in series with a storage circuit (e.g., capacitor 508), this portion of readout circuitry 310 may serve as an analog memory circuit. In other words, switch 506-1 and capacitor 508-1 may serve as an input analog memory circuit for pixel 204-1 and other pixels in the same column or array portion coupled to column line 416-1. In particular, the analog memory circuit may function by closing switch 506-1 to receive a reset level voltage at capacitor 508-1 and opening switch 506-1 to store the reset level voltage at capacitor 508-1. Similarly, switch 506-2 and capacitor 508-2 may serve as an input analog memory circuit for pixel 204-2 and other pixels in the same column or array portion coupled to column line 416-2 (e.g., by isolating a stored reset level voltage at capacitor 508-2 when switch 506-2 is opened).

Amplifier circuitry 510 may have an output terminal that supplies amplifier output signal VOUT. The second input terminal of amplifier circuitry 510 may be coupled to the output terminal of amplifier circuitry 510 via multiple parallel paths. Reset switch 516 may couple the second input terminal of amplifier circuitry 510 to the output terminal of amplifier circuitry 510 via a first one of the parallel paths. Feedback capacitor 512-1 and feedback switch 514-1, which are connected in series, may couple the second input terminal of amplifier circuitry 510 to the output terminal of amplifier circuitry 510 via a second one of the parallel paths. Feedback capacitor 512-2 and feedback switch 514-2, which are connected in series, may couple the second input terminal of amplifier circuitry 510 to the output terminal of amplifier circuitry 510 via a third one of the parallel paths.

Similar to the analog memory circuits formed from the input capacitor and switch combination, analog memory circuits may also be formed from the feedback capacitor and switch combination. In particular, switch 514-1 and capacitor 512-1 may serve as a feedback analog memory circuit for pixel 204-1 and other pixels in the same column or array portion coupled to column line 416-1. As an example, for providing feedback capacitor 512-1 to amplify the input signals from pixel 204-1 and from these other pixels coupled to column line 416-1, switch 512-1 may be closed while switch 512-2 may be opened. Switch 514-2 and capacitor 512-2 may serve as a feedback analog memory circuit for pixel 204-2 and other pixels in the same column or array portion coupled to column line 416-2. As an example, for providing feedback capacitor 512-2 to amplify the input signals from pixel 204-2 and from these other pixels coupled to column line 416-2, switch 512-2 may be closed while switch 512-1 may be opened.

In the example of FIG. 5, readout circuitry 310 may include a corresponding input capacitor 508 (e.g., in an input analog memory circuit) and a corresponding feedback capacitor 512 (e.g., in a feedback analog memory circuit) for each column line 416 coupled to readout circuitry 310. As such, amplifier gain for each of the column lines may be independently controlled or determined (e.g., determined based on a ratio of a capacitance of the input capacitor to a capacitance of the feedback capacitor such as a ratio of capacitance C1 to CF1 for pixel 204-1 and a ratio of capacitance C2 to CF2 for pixel 204-2, as examples). However, this is merely illustrative. If desired, one or more feedback capacitors may be shared between the pixels in different column lines (e.g., a single feedback capacitor may be shared by signals from column line 416-1 and 416-2 for respective amplification operations, although requiring additional reset operations during the amplification operations).

FIG. 6 is a flowchart of illustrative steps for operating shared readout circuitry such as readout circuitry 310 as shown in FIG. 5 and one or more pixels 204 in FIG. 4 during pixel readout operations. In the example of FIG. 6, flowchart 600 may include sequential steps 602, 610, 618, and optionally 628. In some configurations, one or more of these steps may be performed using control circuitry such as row control circuitry 206 in FIG. 2, control and processing circuitry 210 in FIG. 2, storage and processing circuitry 108 in FIG. 1, and/or other control signal generation circuitry to generate, provide, and/or assert corresponding control signals to components (e.g., transistors, switches, etc.) in readout circuitry 310 and pixels 204-1 and 204-2. One or more of these circuitries used to perform the steps in flowchart 600 may be referred to herein as collectively as control circuitry in order to not unnecessarily obscure the present embodiments.

At step 602, the control circuitry may control the readout circuitry to perform a readout operation for a shared reset level voltage from two or more pixels in corresponding different columns of an array (or sub-array). In particular, step 602 may further include exemplary steps 604, 606, and 608.

At step 604, the control circuitry may control the readout circuitry to close all input switches, a reset switch, and all feedback switches for amplifier circuitry in the readout circuitry. As an example, the control circuitry may assert control signals Sel1, Sel2, Sres, Sfb1, and Sfb2 to close switches 506-1, 506-2, 516, 514-1, and 514-2 for amplifier circuitry 510 of FIG. 5, respectively.

At step 606, the readout circuitry to receive reset level signals from the two or more pixels over corresponding column lines. As an example, the control circuitry (e.g., row control circuitry 206 in FIG. 2) may control each of pixels 204-1 and 204-2 to reset a corresponding floating diffusion region (e.g., regions FD1 or FD2 in FIG. 5, or a corresponding region 408 in FIG. 4 for each pixel) by asserting reset transistor control signal RST for transistor 418 in FIG. 4 for each pixel. The control circuitry (e.g., row control circuitry 206 in FIG. 2) may then assert control signals RS1 and RS2 to close switches 412-1 and 412-2, respectively, thereby conveying reset level voltages (stored at floating diffusion regions) from pixels 204-1 and 204-2 to amplifier circuitry 510 in FIG. 5 via corresponding column lines 416-1 and 416-2.

At step 608, the control circuitry may control the readout circuitry to open the reset switch, and downstream circuitry (e.g., analog-to-digital converter (ADC) circuitry) may sample an output of the amplifier circuitry as a reset level signal for the two or more pixels. As an example, the control circuitry may deassert control signal Sres to open switch 516 for amplifier circuitry 510 in FIG. 5. The output signal VOUT for amplifier circuitry 510 in FIG. 5 may be used as an (amplified) reset level signal output associated with both pixels 204-1 and 204-2 (e.g., for a subsequent analog-to-digital conversion operation).

At step 610, the control circuitry may control the readout circuitry to perform a correlated double sampling readout operation for a first pixel in the two or more pixels (based on the shared reset level voltage read out in step 602). In particular, step 610 may further include exemplary steps 612, 614, and 616.

At step 612, the control circuitry may control the readout circuitry to keep the reset switch opened, to open all the input switches, and to keep the feedback switch for the first pixel closed and open any other feedback switches. As an example, the control circuitry may deassert control signals Sres, Sel1, Sel2, and Sfb2 to keep reset switch 516 in an open state and to open switches 506-1, 506-2, and 514-2 for amplifier circuitry 510 in FIG. 5, respectively. Additionally, the control circuitry may assert control signal Sfb1 to keep feedback switch 514-1 for pixel 204-1 in a closed state.

At step 614, the control circuitry may control the readout circuitry to close the input switch for the first pixel, and the readout circuitry may receive an image level signal from the first pixel over a first column line. As an example, the control circuitry (e.g., row control circuitry 206 in FIG. 2) may control each of pixels 204-1 and 204-2 to transfer photodiode-generated image charge to a corresponding floating diffusion region (e.g., regions FD1 or FD2 in FIG. 5, or a corresponding region 408 in FIG. 4 for each pixel) by asserting transfer transistor control signal TX for transistor 406 in FIG. 4 for each pixel. The control circuitry may then assert control signal Sel1 to close switch 506-1 for pixel 204-1 in FIG. 5. Additionally, the control circuitry (e.g., row control circuitry 206 in FIG. 2) may assert control signal RS1 to close switch 412-1, thereby conveying an image level voltage (stored at floating diffusion region FD1) from pixel 204-1 to amplifier circuitry 510 in FIG. 5 via column line 416-1.

At step 616, downstream circuitry (e.g., ADC circuitry) may sample the output of the amplifier circuitry as an image level signal for the first pixel. As an example, the output signal VOUT for amplifier circuitry 510 in FIG. 5 may be used as an (amplified) image level signal output associated with a CDS readout signal for pixel 204-1.

At step 618, the control circuitry may control the readout circuitry to perform a correlated double sampling readout operation for a second pixel in the two or more pixels (based on the shared reset level voltage read out in step 602). In particular, step 618 may further include exemplary steps 620, 622, 624, and 626.

At step 620, the control circuitry may control the readout circuitry to open the input and feedback switches for the first pixel, and close and subsequently (re-)open the reset switch. As an example, the control circuitry may deassert control signals Sel1 and Sfb1 to open input switch 506-1 and feedback switch 514-1 for pixel 204-1. The control circuitry may then assert signal Sres to briefly close reset switch 516 and subsequently deassert signal Sres to re-open reset switch 516, thereby resetting the input and output terminals of amplifier circuitry 510 in FIG. 5.

At step 622, the control circuitry may control the readout circuitry to keep the reset switch opened, to open all the input switches, and to close the feedback switch for the second pixel and open any other feedback switches. As an example, the control circuitry may deassert control signals Sres, Sel1, Sel2, and Sfb1 to keep reset switch 516 in an open state and to open switches 506-1, 506-2, and 514-1 for amplifier circuitry 510 in FIG. 5, respectively. Additionally, the control circuitry may assert control signal Sfb2 to open feedback switch 514-2 for pixel 204-2.

At step 624, the control circuitry may control the readout circuitry to close the input switch for the second pixel, and the readout circuitry may receive an image level signal from the second pixel over a second column line. As an example, the control circuitry may assert control signal Sel2 to close switch 506-2 for pixel 204-2 in FIG. 5. Additionally, the control circuitry (e.g., row control circuitry 206 in FIG. 2) may assert control signal RS2 to close switch 412-2, thereby conveying an image level voltage (stored at floating diffusion region FD2) from pixel 204-2 to amplifier circuitry 510 in FIG. 5 via column line 416-2.

At step 626, downstream circuitry (e.g., ADC circuitry) may sample the output of the amplifier circuitry as an image level signal for the second pixel. As an example, the output signal VOUT for amplifier circuitry 510 in FIG. 5 may be used as an (amplified) image level signal output associated with a CDS readout signal for pixel 204-2.

Optionally, at step 628, the control circuitry may control the readout circuitry to perform any additional correlated double sampling readout operations for any additional pixels in the two or more pixels (e.g., in scenarios where three or more column lines are coupled to the same shared readout circuitry or to the same shared amplifier circuitry). In the exemplary configuration of FIG. 5, the control circuitry may proceed without step 612.

Various embodiments have been described illustrating image sensors having column readout circuitry shared between different pixel columns.

In various embodiments of the present invention, an image sensor may include image sensor pixels arranged in columns and rows, a first set of image sensor pixels being coupled to a first column line and a second set of image sensor pixels being coupled to a second column line. The image sensor may also include column readout circuitry having amplifier circuitry. The first column line may be coupled to an input terminal of the amplifier circuitry and the second column line may be coupled the input terminal of the amplifier circuitry. The first column line may be coupled to the input terminal of the amplifier circuitry via a first analog memory circuit, and the second column line may be coupled to the input terminal of the amplifier circuitry via a second analog memory circuit. The first analog memory circuit may include a first switch connected in series with a first input capacitor for the amplifier circuitry, and the second analog memory circuit may include a second switch connected in series with a second input capacitor for the amplifier circuitry. The amplifier circuitry may include an output terminal, and a feedback capacitor couples the input terminal of the amplifier circuitry to the output terminal of the amplifier circuitry. The feedback capacitor and a switch may be connected in series to form a third analog memory circuit coupling the input terminal of the amplifier circuitry to the output terminal of the amplifier circuitry. An additional feedback capacitor and an additional switch may be connected in series to form a fourth analog memory circuit coupling the input terminal of the amplifier circuitry to the output terminal of the amplifier circuitry. The amplifier circuitry may include an additional input terminal configured to receive a reference voltage. A reset switch may couple the input terminal of the amplifier circuitry to the output terminal of the amplifier circuitry. The reset switch, the third analog memory circuit, and the fourth memory analog circuit may be connected in parallel along three different paths between the input terminal of the amplifier circuitry and the output terminal of the amplifier circuitry. The first and third analog memory circuits may be configured to store and amplify signals associated with the first set of image sensor pixels, and the second and fourth analog memory circuits may be configured to store and amplify signals associated with the second set of image sensor pixels.

In various embodiments of the present invention, an image sensor may include an image sensor pixel array having a first column of pixels coupled to a first readout path and a second column of pixels coupled to a second readout path, amplifier circuitry having an input terminal, and first and second capacitors coupled to the input terminal of the amplifier circuitry. The first readout path may be coupled to the input terminal of the amplifier circuitry via the first capacitor and a first switch, and the second readout path may be coupled to input terminal of the amplifier circuitry via the second capacitor and a second switch. The amplifier circuitry may have an output terminal, the input terminal of the amplifier circuitry may be coupled to the output terminal of the amplifier circuitry via a third capacitor and a third switch along a first path, and the input terminal of the amplifier circuitry may be coupled to the output terminal of the amplifier circuitry via a fourth capacitor and a fourth switch along a second path. The image sensor pixel array may include additional columns of pixels, each coupled to a corresponding readout path, and every pair of columns in the additional columns of pixels may be coupled to corresponding shared amplifier circuitry.

In some embodiments, the image sensor pixel array may be split into upper and lower sub-arrays, and the first and second columns of pixels are formed in the upper sub-array.

In some embodiments, the image sensor pixel array may be split into upper and lower sub-arrays, and the first and second columns of pixels are formed in the lower sub-array. Third and fourth columns of pixels in the upper sub-array may be coupled to an input terminal at additional amplifier circuitry via third and fourth respective readout paths.

In various embodiments of the present invention, an imaging system may include an array of image sensor pixels, shared readout circuitry coupled to a first pixel in a first column of the array and coupled to a second pixel in a second column of the array, and control circuitry configured to control the shared readout circuitry to perform a shared reset level readout operation for the first and second pixels. the control circuitry may be configured to control the readout circuitry to perform a correlated double sampling readout operation for the first pixel and to control the readout circuitry to perform a correlated double sampling readout operation for the second pixel. The shared readout circuitry may include amplifier circuitry coupled to the first pixel via a first analog memory circuit and coupled to the second pixel via a second analog memory circuit. The first and second analog memory circuits may be configured to store a reset level voltage during the shared reset level readout operation. The second analog memory circuit may be configured to store the reset level voltage while the readout circuitry performs the correlated double sampling readout operation for the first pixel. The readout circuitry may include first and second feedback capacitors for the amplifier circuitry. The first feedback capacitor may be useable during the correlated double sampling readout operation for the first pixel, and the second feedback capacitor may be useable during the correlated double sampling readout operation for the second pixel.

The foregoing is merely illustrative and various modifications can be made to the described embodiments. The foregoing embodiments may be implemented individually or in any combination.

What is claimed is:

1. An image sensor comprising:
image sensor pixels arranged in columns and rows, a first set of image sensor pixels being coupled to a first column line and a second set of image sensor pixels being coupled to a second column line; and
column readout circuitry having amplifier circuitry, the amplifier circuitry having an input terminal and an output terminal, wherein the first column line is coupled to the input terminal, the second column line is coupled the input terminal, a first feedback capacitor for the first column line couples the input terminal to the output terminal, and a second feedback capacitor for the second column line couples the input terminal to the output terminal.

2. The image sensor defined in claim 1, wherein the first column line is coupled to the input terminal of the amplifier circuitry via a first analog memory circuit and the second column line is coupled to the input terminal of the amplifier circuitry via a second analog memory circuit.

3. The image sensor defined in claim 2, wherein the first analog memory circuit comprises a first switch connected in series with a first input capacitor for the amplifier circuitry and the second analog memory circuit comprises a second switch connected in series with a second input capacitor for the amplifier circuitry.

4. The image sensor defined in claim 2, wherein the first feedback capacitor and a switch are connected in series to form a third analog memory circuit coupling the input terminal of the amplifier circuitry to the output terminal of the amplifier circuitry.

5. The image sensor defined in claim 4, wherein the second feedback capacitor and an additional switch are connected in series to form a fourth analog memory circuit coupling the input terminal of the amplifier circuitry to the output terminal of the amplifier circuitry.

6. The image sensor defined in claim 5, wherein the amplifier circuitry includes an additional input terminal configured to receive a reference voltage and a reset switch couples the input terminal of the amplifier circuitry to the output terminal of the amplifier circuitry.

7. The image sensor defined in claim 6, wherein the reset switch, the third analog memory circuit, and the fourth analog memory circuit are connected in parallel along three different paths between the input terminal of the amplifier circuitry and the output terminal of the amplifier circuitry.

8. The image sensor defined in claim 5, wherein the first and third analog memory circuits are configured to store and amplify signals associated with the first set of image sensor pixels and the second and fourth analog memory circuits are configured to store and amplify signals associated with the second set of image sensor pixels.

9. The image sensor defined in claim 1, wherein a third set of image sensor pixels are coupled to a third column line and the third column line is coupled to the input terminal of the amplifier circuitry.

10. An image sensor comprising:
an image sensor pixel array having a first column of pixels coupled to a first readout path and a second column of pixels coupled to a second readout path;
amplifier circuitry having an input terminal; and
first and second capacitors coupled to the input terminal of the amplifier circuitry, wherein the first readout path is coupled to the input terminal of the amplifier circuitry via the first capacitor and a first switch, the first capacitor is configured to receive reset level and image level signals for the first column of pixels, the second readout path is coupled to input terminal of the amplifier circuitry via the second capacitor and a second switch, and the second capacitor is configured to receive reset level and image level signals for the second column of pixels.

11. The image sensor defined in claim 10, wherein the amplifier circuitry has an output terminal, the input terminal of the amplifier circuitry is coupled to the output terminal of the amplifier circuitry via a third capacitor and a third switch along a first path, and the input terminal of the amplifier circuitry is coupled to the output terminal of the amplifier circuitry via a fourth capacitor and a fourth switch along a second path.

12. The image sensor defined in claim 11, wherein the image sensor pixel array includes additional columns of pixels, each coupled to a corresponding readout path, and every pair of columns in the additional columns of pixels is coupled to corresponding shared amplifier circuitry.

13. The image sensor defined in claim 11, wherein the image sensor pixel array is split into upper and lower sub-arrays, and the first and second columns of pixels are formed in the upper sub-array.

14. The image sensor defined in claim 11, wherein the image sensor pixel array is split into upper and lower sub-arrays, and the first and second columns of pixels are formed in the lower sub-array.

15. The image sensor defined in claim 14, wherein third and fourth columns of pixels in the upper sub-array are coupled to an input terminal at additional amplifier circuitry via third and fourth respective readout paths.

16. An imaging system comprising:
an array of image sensor pixels;
shared readout circuitry coupled to a first pixel in a first column of the array and coupled to a second pixel in a second column of the array; and
control circuitry configured to control the shared readout circuitry to perform a shared reset level readout operation for the first and second pixels.

17. The imaging system defined in claim 16, wherein the control circuitry is configured to control the readout circuitry to perform a correlated double sampling readout operation for the first pixel and to control the readout circuitry to perform a correlated double sampling readout operation for the second pixel.

18. The imaging system defined in claim 17, wherein the shared readout circuitry comprises amplifier circuitry coupled to the first pixel via a first analog memory circuit and coupled to the second pixel via a second analog memory circuit, and wherein the first and second analog memory circuits are configured to store a reset level voltage during the shared reset level readout operation.

19. The imaging system defined in claim 18, wherein the second analog memory circuit is configured to store the reset level voltage while the readout circuitry performs the correlated double sampling readout operation for the first pixel.

20. The imaging system defined in claim 19, wherein the readout circuitry includes first and second feedback capacitors for the amplifier circuitry, wherein the first feedback capacitor is useable during the correlated double sampling readout operation for the first pixel, and the second feedback capacitor is useable during the correlated double sampling readout operation for the second pixel.
